(19) United States
(12) Patent Application Publication
(10) Pub. No.: US 2015/0208329 A1
(43) Pub. Date: Jul. 23, 2015

(54) SUPPORTING WIRELESS LOCAL AREA NETWORK BASED POSITIONING

(71) Applicant: Nokia Corporation, Espoo (FI)

(72) Inventors: Lauri Aarne Johannes Wirola, Tampere (FI); Tommi Antero Laine, Tampere (FI)

(73) Assignee: Nokia Corporation, Espoo (FI)

(21) Appl. No.: 14/417,362

(22) PCT Filed: Aug. 10, 2012
(86) PCT No.: PCT/IB2012/054081

§ 371 Date: Jan. 26, 2015

(51) Int. Cl. H04W 48/16; H04W 64/00

(52) U.S. Cl. CPC H04W 48/16; H04W 64/00; H04W 84/12

(57) ABSTRACT

An apparatus retrieves information on an availability of data on wireless local area networks for a particular area from a memory. The particular area is identified based on cellular measurements at a mobile terminal. The apparatus provides the retrieved information as a basis for a decision whether to perform a scan for wireless local area networks at the mobile terminal as a basis for a wireless local area network based positioning. Information on an availability of data on wireless local area networks for a plurality of areas may be provided to a mobile terminal by a server.

### FIELD OF THE DISCLOSURE

The invention relates to the field of positioning and more specifically to the field of wireless local area network based positioning.

### BACKGROUND

Modern global cellular and non-cellular positioning technologies are based on generating large global databases containing information on cellular and non-cellular signals. The information may originate entirely or partially from users of these positioning technologies.

The information provided by users is typically in the form of “fingerprints”, which contain a location that is estimated based on, e.g., received satellite signals of a global navigation satellite system (GNSS) and measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.).

This data may then be transferred to a server or cloud, where the data may be collected and where further models may be generated based on the data for positioning purposes. Such further models can be coverage area estimates, base station positions and/or radio channel models, a base station being an exemplary node of a communication network. In the end, these refined models may be used for estimating the position of mobile terminals.

Fingerprints do not necessarily have to comprise a GNSS based position. They could also include cellular and/or WLAN measurements only. In this case the fingerprint could be assigned a position for example based on a WLAN based positioning in a server. Such self-positioned fingerprints can be used to learn cellular network information, in case there are cellular measurements in the fingerprint. Moreover, in the set of WLAN measurements in the fingerprint there may be, in addition to measurements for known WLAN access points, also measurements for unknown access points, and the position of the unknown access points can be learned through these self-positioned fingerprints. Finally, more data can be learned for previously known access points based on self-positioned fingerprints.

### SUMMARY OF SOME EMBODIMENTS OF THE INVENTION

For a first aspect, a method is described, which comprises retrieving, by an apparatus, information on an availability of data on wireless local area networks for a particular area from a memory, the particular area being identified based on cellular measurements at a mobile terminal. The method further comprises providing, by the apparatus, the retrieved information as a basis for a decision whether to perform a scan for wireless local area networks at the mobile terminal as a basis for a wireless local area network based positioning.

For a second aspect, a method is described, which comprises receiving, by a server, a request from a mobile terminal for information on an availability of data on wireless local area networks for each of a plurality of areas. The method further comprises providing, by the server, the requested information to the mobile terminal, as a basis for decisions at the mobile terminal whether to perform a scan for wireless local area networks in a particular area.

Moreover an apparatus is described, which comprises means for realizing the actions of the method presented for the first aspect or means for realizing the actions of the method presented for the second aspect.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover an apparatus is described, which comprises at least one processor and at least one memory including computer program code, the at least one memory and the computer program code configured to, with the at least one processor, cause an apparatus at least to perform the actions of the method presented for the first aspect or to perform the actions of the method presented for the second aspect.

Moreover a non-transitory computer readable storage medium is described, in which computer program code is stored. The computer program code causes an apparatus to realize the actions of the method presented for the first aspect or to realize the actions of the method presented for the second aspect when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer or an integrated or exchangeable memory of a mobile terminal, or be intended for distribution of the program code, like an optical disc.

It is to be understood that also the computer program code by itself has to be considered an embodiment of the invention.

Moreover a system is described, which comprises an apparatus configured to support the presented first method, with the apparatus being a mobile terminal. In addition, the system may comprise a server configured to provide the data on wireless access networks and/or a server configured to provide information on the availability of data about wireless local area networks for a plurality of areas for download.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal in the case of the first aspect or a mobile terminal in the case of the second aspect.

In one embodiment, the described methods are information providing methods, and the described apparatuses are information providing apparatuses. In one embodiment, the described means of an apparatus are processing means.

In certain embodiments of the described methods, the methods are methods for supporting a wireless local area network based positioning. In certain embodiments of the described apparatuses, the apparatuses are apparatuses for supporting a wireless local area network based positioning.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an exemplary embodiment of an apparatus;

FIG. 2 is a flow chart illustrating an exemplary embodiment of a method according to the first aspect;

FIG. 3 is a flow chart illustrating an exemplary embodiment of a method according to the second aspect;

FIG. 4 is a schematic block diagram of a first exemplary embodiment of a system;

FIG. 5 is a flow chart illustrating an exemplary operation in the system of FIG. 4;

FIG. 6 is a schematic block diagram of a second exemplary embodiment of a system; and

FIG. 7 is a flow chart illustrating an exemplary operation in the system of FIG. 6.

### DETAILED DESCRIPTION OF THE FIGURES

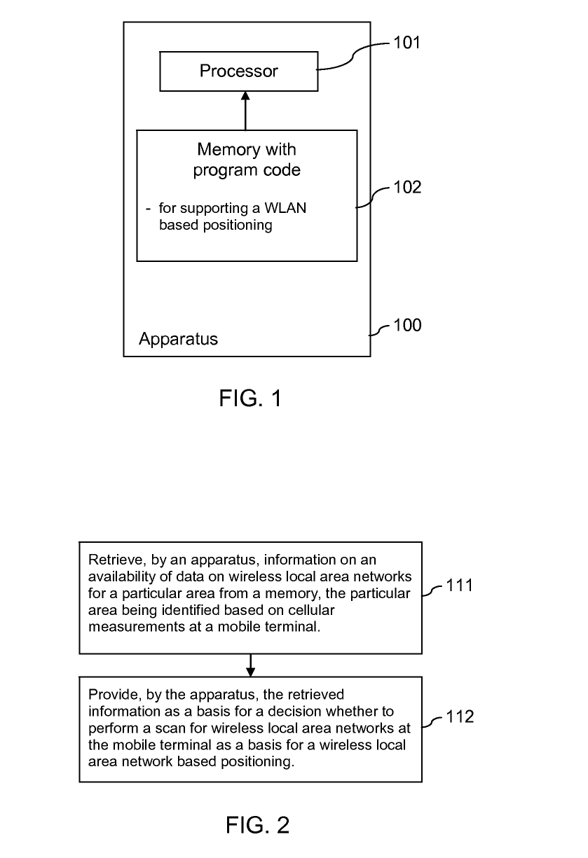

FIG. 1 is a schematic block diagram of an apparatus 100. Apparatus 100 comprises a processor 101 and, linked to processor 101, a memory 102. Memory 102 stores computer program code for supporting an efficient wireless local area network based positioning. Processor 101 is configured to execute computer program code stored in memory 102 in order to cause an apparatus to perform desired actions.

Apparatus 100 could be a mobile device, like a communication terminal, a mobile phone, a smart phone, a laptop or a tablet computer. Alternatively, apparatus 100 could be a stationary device, like a server. Apparatus 100 could equally be a module for a mobile device or a stationary device, like a chip, circuitry on a chip or a plug-in board. Apparatus 100 is an exemplary embodiment of any apparatus according to the first aspect. Optionally, apparatus 100 could have various other components, like a data interface, a user interface, a further memory, a further processor, etc.

An operation of apparatus 100 will now be described with reference to the flow chart of FIG. 2. The operation is an exemplary embodiment of a method according to the first aspect. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus retrieves information on an availability of data on wireless local area networks for a particular area from a memory, the particular area being identified based on cellular measurements at a mobile terminal. (action 111)

The apparatus furthermore provides the retrieved information as a basis for a decision whether to perform a scan for wireless local area networks at the mobile terminal as a basis for a wireless local area network based positioning. (action 112)

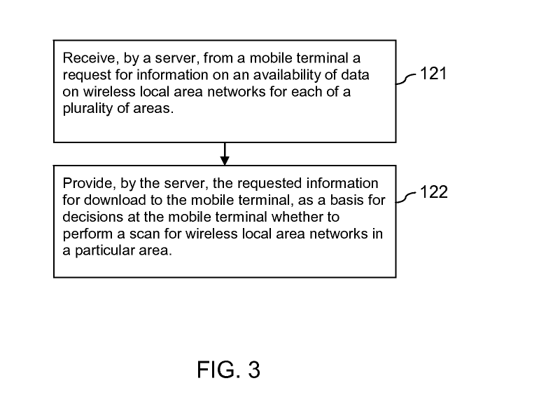

FIG. 3 is a flow chart which illustrates an exemplary embodiment of a method according to the second aspect.

The actions of FIG. 3 can be carried out by an apparatus having the same structure as apparatus 100 presented in FIG. 1, therefore, reference is made to FIG. 1 again. In this case, apparatus 100 is an exemplary embodiment of any apparatus according to the second aspect. Processor 101 and the program code stored in memory 102 cause a mobile terminal to perform the operation presented in FIG. 3 when the program code is retrieved from memory 102 and executed by processor 101. The apparatus can be a server or a module for a server.

The server receives from a mobile terminal a request for information on an availability of data on wireless local area networks for each of a plurality of areas. (action 121)

The server furthermore provides the requested information to the mobile terminal, as a basis for decisions at the mobile terminal whether to perform a scan for wireless local area networks in a particular area. (action 122)

The invention is based on the consideration that today's applications are ever more demanding with respect to awareness of the location of mobile devices. For many applications, position information needs to be available on a continuous basis or at frequent intervals and at a high accuracy, without compromising the battery life of the mobile device.

For mobile devices supporting cellular communication, one viable option to enable continuous location awareness is to utilize cellular positioning. Cellular measurements are usually performed by a cellular modem of such a mobile device at relatively high frequency anyhow, for example at a rate of once per second or even more frequently. When information from cellular measurements is combined with an offline cellular radio map that is stored at the mobile device, the device can keep its location up to date all the time in the background without significant impacts on the battery life. An offline cellular radio map may comprise for example information on coverage areas of cellular nodes or on radio models of cellular nodes, etc. An offline cellular radio map can be downloaded to the mobile device or pre-installed.

However, while cellular positioning can provide a location at an accuracy of 50-500 meters in urban conditions, applications often request a better accuracy than can be provided by the cellular positioning.

In many scenarios, a better accuracy can be obtained by means of a WLAN based positioning. However, storing offline WLAN radio maps for large areas in a mobile device for supporting the positioning may require more storage space than desired. WLAN radio maps may take up much more storage space than cellular radio maps, because there may be hundreds of thousands of WLAN access points per square kilometer, whereas the cellular base station density may be several orders of magnitude lower. In order to overcome this problem, WLAN based positioning may be used in an online-mode. That is, when a WLAN based position is requested, the mobile device makes a WLAN scan in order to detect signals transmitted by WLAN access points in the environment. The mobile device then sends the scan results to a server. The server calculates the position of the mobile device based on its global WLAN access point database and returns the results to the mobile device.

Still, the problem remains that WLAN scans use up much energy, also in those areas for which it turns out that the server does not have sufficient WLAN data for a WLAN based positioning.

Therefore, certain embodiments of the invention may enable an apparatus to obtain information on the availability of WLAN data for a particular area. The particular area can be determined based on cellular measurements of a mobile terminal; it is thus the area in which a mobile terminal is currently assumed to be located. In certain embodiments, a server may provide information on the availability of WLAN data for a plurality of areas for downloaded to a mobile terminal.

Certain embodiments may have the effect that a mobile terminal is enabled to obtain information to make a decision on whether to perform a WLAN scan and to attempt a WLAN based positioning. There may or may not be sufficient available data for WLAN access points in a particular area for performing a WLAN based positioning. Avoiding a WLAN scan at a given location when a WLAN based positioning is not promising may save processing power. It may also save bandwidth, and thus possibly costs to a user, in case the WLAN based positioning involves a communication between devices, for instance between a mobile terminal and a server.

Apparatus 100 illustrated in FIG. 1 and the operation illustrated in FIG. 2 or FIG. 3 may be implemented and refined in various ways.

The WLAN data could comprise any data that is suitable for supporting a WLAN based positioning. It could comprise for instance a mapping of the BSSID of a respective WLAN access point to a location of the WLAN access point, and/or to an indication of the coverage area of the WLAN access point and/or to parameters of a radio propagation model for the WLAN access point. The parameters of a radio propagation model could comprise for instance parameters for a pathloss model or parameters for a received signal strength model. The WLAN data could be based for instance on collected fingerprints.

The cellular measurements could be measurements on signals transmitted by nodes of any kind of cellular communication system, for instance a global system for mobile communications (GSM), a 3rd Generation Partnership Project (3GPP) based cellular system like a wide-band code division multiple access (WCDMA) system or a time division synchronous CDMA (TD-SCDMA) system, a 3GPP2 system like a CDMA2000 system, a long term evolution (LTE) or LTE-Advanced system, or any other type of cellular system, like a worldwide interoperability for microwave access (WiMAX) system. The node of a cellular communication system could be for instance a transceiver or a base station of the cellular communication system. In general, a node of a cellular communication system could be an entity serving exactly one cell, or an entity serving a plurality of cells from a single position.

The cellular measurements could be used for identifying a particular area simply by indicating a serving cell identity, since the service cell is obviously covering the area in which the mobile terminal is currently located. Alternatively, the cellular measurements could be used for determining the current position of the mobile terminal, either once or repeatedly for a continuous location awareness. The respective position can then be used for selecting an area comprising the position.

In an exemplary embodiment, the memory comprises information on an availability of data on wireless local area networks embedded in a cellular radio map. This may have the effect of enabling a particularly efficient storage of the availability information. In a cellular radio map, entries for each cellular node may be stored with an association with an identity of the node. If the information on an availability of data on WLANs is embedded in the cellular radio map, such information may be associated with the same identities of the cellular nodes. The expression “radio map” is to be understood in a broad sense. It may comprise for instance at least a partial identity of a plurality of cells or nodes and, associated with each identity, an indication of the strength of signals of a node captured at different positions, and/or of the coordinates of the node and/or of the coverage area of the node and/or of radio propagation model parameters for the node, etc.

However, it is to be understood that the information on the availability of data on WLANs could also be provided separately from a cellular radio map and thus be decoupled from any cellular data. The information could then be considered as an independent “WLAN heat map”. In this scenario, cellular positioning could provide continuous or non-continuous location awareness, and in case a higher accuracy is required the WLAN heat map could be accessed with a known location to find out whether a WLAN positioning is possible at the current location. If such a heat map is transmitted to a mobile terminal, this requires less transmission bandwidth and less storage space than a WLAN radio map, which comprises the WLAN data that is required for the actual WLAN based positioning.

In an exemplary embodiment, available data on wireless local area networks is stored separately from the information on an availability of data on wireless local area networks. This may have the effect that the information on the availability of WLAN data could be stored in a mobile terminal and the WLAN data could be stored at a server or in a memory accessible by a server. The information on the availability of WLAN data and the WLAN data itself could also be stored in different memories in the same device or even in different databases in the same memory. It has to be noted however that, in particular at a server side, the information on the availability of WLAN data could even be embedded in a database comprising the WLAN data.

The information on the availability of WLAN data for a particular area can be of different types.

In an exemplary embodiment, the memory comprises for each of a plurality of areas a binary value indicating an acceptable availability of data on wireless local area networks. This may have the effect that the required storage space for the information is particularly small and moreover that the processing power required for the evaluation is particularly low.

Alternatively or in addition, the memory could comprise for each of a plurality of areas a value indicating a density of wireless local area networks access points for which data is available. The value indicating a density could be a direct density value. In the case of equal size areas, such a direct value could represent for instance the number of access points, for which data is available for each area. A direct value could equally be the relation of the number of access points, for which data is available in an area, to the size of the area, and thus even a floating point value. The value indicating a density could also be an index representing an element of a limited set of elements, like high density, medium density, low density and insufficient density, or similar.

Alternatively or in addition, the memory could comprise for each of a plurality of areas a value indicating an expected accuracy of a wireless local area network based positioning in the area. The value indicating the expected accuracy could again be for instance an index representing an element of a limited set of elements, like high accuracy, medium accuracy, low accuracy and insufficient accuracy, or similar.

Using a memory which indicates a density of access points for which data is available in an area or an expected accuracy of a WLAN based positioning for the area may have the effect that more flexibility is enabled than with a binary value. For example, different applications may require positions with different accuracies. If the memory comprises an indication of an achievable accuracy or of a density of WLAN access points, this may be taken into account for deciding on whether an acceptable availability of WLAN data is given in a particular situation.

In an exemplary embodiment, the particular area corresponds to a cell area. In this case, the area could simply be identified by a cell identity. Alternatively, for obtaining a higher granularity, the area could be a cell sector. In this case, the cell sector and thus the area could be identified by cell identity and absolute radio frequency channel (ARFCN).

Further alternatively, a considered region could be divided into tiles, and the particular area could be the area of a tile. A region could be divided for instance into tiles of equal size, for example 2-by-2 km tiles. A data record for each tile could carry information on the cellular network cells in the area of the tile. The information on the availability of WLAN data for a particular area of a tile could then be embedded in addition in the data record for the tile. It is to be understood, however, that a tile approach could also be used for storing information on the availability of WLAN data only. Alternatively, for obtaining a higher granularity, the particular area could be a tile subregion. In both cases, the particular area could be identified by a cellular based position of a mobile terminal, or by combination of the cell identities of several cells observed by the mobile terminal in cellular measurements at a current location.

In an exemplary embodiment, the particular area is identified by a cell identity or cell sector identity, or by a location of the mobile terminal determined by means of a cell based positioning. Using a cell identity or a cell sector identity may have the effect that it is easy to determine from the cellular measurements and that it does not require extra processing load for determining the position. It is to be understood that a combination of identities of several cells, which can be detected at a current location, could be exploited as well. Using a location of the mobile terminal determined by means of a cell based positioning may have the effect that the availability of WLAN data can be determined with a better match to the current location of the mobile terminal, in particular if the area covered by a cell is large. Using a location of the mobile terminal determined by means of a cell based positioning may further have the effect that the information on the availability of WLAN data does not have to be stored with a mapping to cell identities.

In an exemplary embodiment, the method further comprises informing an application about an achievable positioning accuracy. The application can be for instance an application of the mobile terminal or an application of some server. If it has been decided that no WLAN scan is to be performed, the achievable accuracy could be an accuracy that may be achieved with a cellular based positioning. It can be a predetermined value, or a value that is estimated in the scope of the cellular based positioning. Otherwise, the indication of the achievable accuracy may be based on the information on availability of WLAN data. This may have the effect that the application may take the achievable accuracy into account and possibly inform the user.

The memory storing the information on the availability of data on WLAN access points may be accessible to the mobile terminal or to some other device, like a server.

If the information on the availability of data on WLAN access points is accessible to a mobile terminal, only this information, indicating whether a WLAN based positioning is possible in a given area, has to be provided to and stored at the mobile terminal, not the entire WLAN data.

In an exemplary embodiment, information on the availability of data on wireless local area networks for each of a plurality of areas is pre-loaded in the memory of a mobile terminal, for instance during a manufacturing process. Alternatively, a mobile terminal could request and receive the information from a server. The mobile terminal could then store the received information in a memory, as a basis for the retrieving of information on an availability of data on wireless local area networks for the particular area. Optionally, the information provided by a server could not be global information, but only information for a selected region. The request to the server could include to this end an indication of the selected region, or an indication of a current position of the mobile terminal

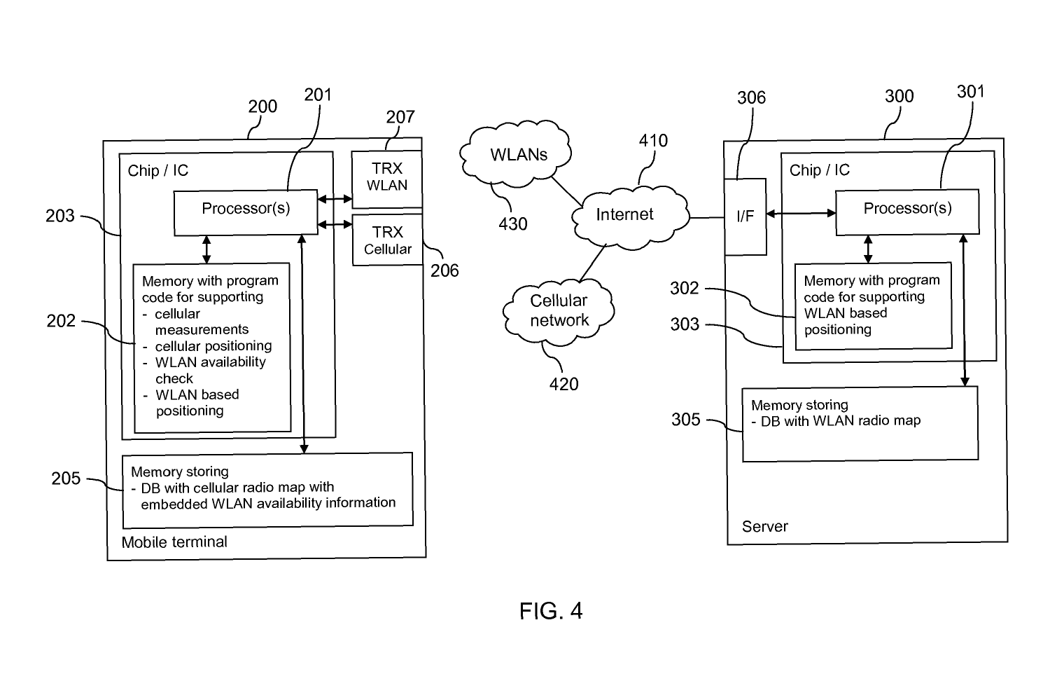

FIG. 4 is a schematic block diagram of a first exemplary system supporting an efficient WLAN based positioning.

The system comprises a mobile terminal 200 and a server 300. Server 300 is connected to a network 410, for example the Internet. Server 300 could also belong to network 410. Network 410 is suited to interconnect server 300 with mobile terminal 200 via a cellular network 420 or via any of a plurality of WLANs 430.

Mobile terminal 200 could be for instance a communication terminal, like a mobile phone or a laptop. It comprises a processor 201 that is linked to a first memory 202, to a second memory 205, to a cellular transceiver 206 and to a WLAN transceiver 207. Processor 201 is configured to execute computer program code, including computer program code stored in memory 202, in order to cause mobile terminal 200 to perform desired actions.

Memory 202 stores computer program code for checking the availability of WLAN data. The program code could belong for instance to a comprehensive positioning application stored in memory 202, which may support in addition collection of cellular measurements, cellular positioning and WLAN based positioning. In addition, memory 202 may store computer program code implemented to realize other functions, as well as any kind of data. Some program code may belong for instance to one or more applications that make use of the current position of mobile terminal 200.

Processor 201 and memory 202 may optionally belong to a chip or an integrated circuit 203, which may comprise in addition various other components, for instance a further processor or a further memory or a part of transceiver 206 or 207, etc.

Memory 205 stores a database (DB) which can be accessed by processor 201. The database is suited to comprise data of a cellular radio map and, embedded, information on the availability of WLAN data. The cellular information in the radio map may be associated with a respective cell identity or with a respective cell sector identity. The embedded information on availability of WLAN data may equally be associated with a respective cell identity or with a respective cell sector identity. For instance, if the information is given per cell sector and there are eight 45-degree sectors, this may yield a very fine granularity in small urban cells having a radius of a few hundred meters. Memory 205 may be for example an integrated memory of mobile terminal 200 or an exchangeable memory card. Optionally, it could be integrated in integrated circuit 203 as well.

Transceiver 206 may enable an access to a cellular communication network 420, like a GSM or Universal Mobile Telecommunications System (UMTS) network. Transceiver 207 may enable an access to WLANs 430.

In addition, mobile terminal 200 could comprise various other components, like a user interface and a GNSS receiver (not shown).

Component 203 or mobile terminal 200 could correspond to exemplary embodiments of an apparatus according to the first aspect.

Server 300 may support a WLAN based positioning of mobile terminals. Server 300 may be for instance a dedicated positioning server or some other kind of server. It comprises a processor 301 that is linked to a first memory 302, to a second memory 305 and to an interface (I/F) 306. Processor 301 is configured to execute computer program code, including computer program code stored in memory 302, in order to cause server 300 to perform desired actions.

Memory 302 stores computer program code for supporting WLAN based positioning of mobile terminals. In addition, memory 302 may store computer program code implemented to realize other functions, as well as any kind of data.

Processor 301 and memory 302 may optionally belong to a chip or an integrated circuit 303, which may comprise in addition various other components, for instance a further processor or a further memory.

Memory 305 stores at least a database with WLAN data enabling a WLAN based positioning. Such data could comprise, in addition to WLAN access point identities, the position of WLAN access points, the coverage area of WLAN access points and/or radio propagation model parameters for WLAN access points. In addition, memory 305 could store other data. It is to be understood that the database could also be stored in a memory that is external to server 300; such a memory could be for instance on another physical or virtual server.

Interface 306 is a component which enables server 300 to communicate with other servers or devices, like mobile terminal 200, via network 410. Interface 206 could comprise for instance a TCP/IP socket.

Cellular communication network 420 comprises a plurality of base stations operating as nodes of the network. Each WLAN 430 comprises at least one access point. Each of the nodes and access points transmits signals that can be observed in a certain associated area. The cell areas may be overlapping, and the coverage areas of different WLAN access points may equally be overlapping.

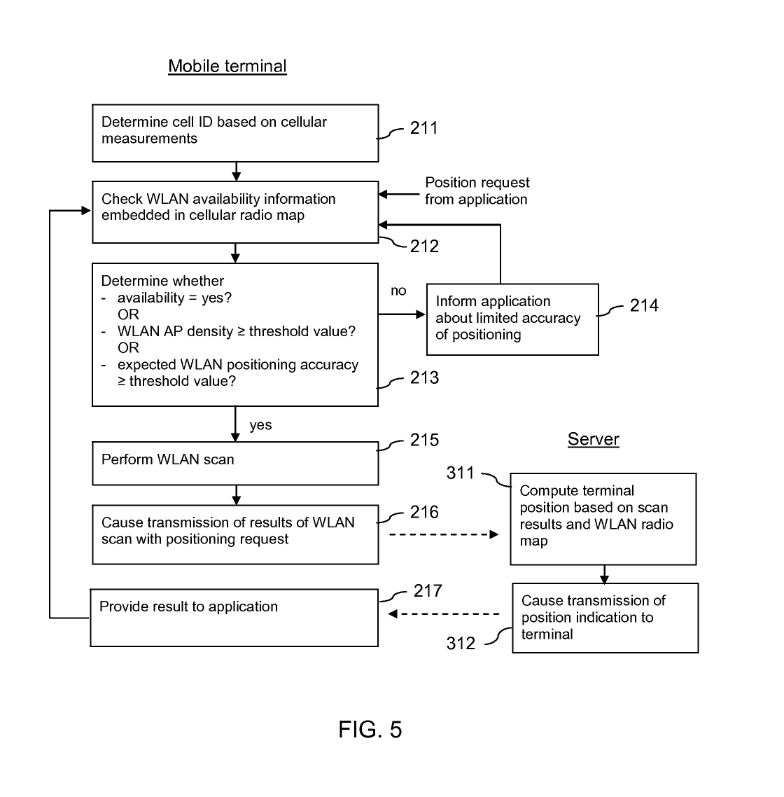

An exemplary operation in the system of FIG. 4 will now be described with reference to the flow chart of FIG. 5.

Operations at mobile terminal 200 are presented essentially on the left hand side of FIG. 5. Processor 201 and the program code stored in memory 202 cause terminal 200 to perform the presented operations when the program code is retrieved from memory 202 and executed by processor 201. Operations at server 300 are presented in FIG. 5 on the right hand side at the bottom. Processor 301 and the program code stored in memory 302 cause server 300 to perform the presented operations when the program code is retrieved from memory 302 and executed by processor 301.

During an exemplary operation in the system of FIG. 5, mobile terminal 200 performs cellular measurements at regular intervals, for instance once per second, for detecting signals transmitted by one or more nodes of cellular network 420. Cellular signals are received and pre-processed by transceiver 206. Based on these measurements, mobile terminal 200 may determine an identification of a cell and thus of a node, for instance a global cell identity and/or a local cell identity of the serving cell and optionally of other observable cells. In the case of sectorized cells, mobile terminal 200 may determine in addition an identification of a cell sector. (action 211) Mobile terminal 200 could also track its position in a conventional manner based on the information in the cellular measurements and the cellular radio map stored in the database in memory 205. For example, if the radio map comprises the position of cellular nodes associated with a respective cell identification, the position of mobile terminal 200 could be determined to correspond to the position of the node of the serving cell or to the averaged position of various cellular nodes from which signals can be received. If the radio map comprises the coverage area of cellular nodes associated with a respective cell identification, the position of mobile terminal 200 could be determined to correspond to the coverage area of the current serving cell or to the intersection of the coverage areas of all cells from which signals are currently received. If the radio map comprises radio propagation model parameters for cellular nodes associated with a respective cell identification, and if the cellular measurements comprise signal strength measurements, the distance of mobile terminal 200 to the serving node or to different cellular nodes could be determined The distance to one or more nodes could then be evaluated for determining the position of mobile terminal 200.

When an application of mobile terminal 200 now requests the current position of mobile terminal 200 with an accuracy that cannot be achieved with cellular based positioning, mobile terminal 200 may check at first the availability of WLAN data for the current location. (action 212) The application may be internal to mobile terminal 200 or external. Since the information on the availability is embedded in the cellular radio map in the database in memory 205, mobile terminal 200 may simply access the data for the determined serving cell identity or serving cell sector identity in the radio map, and extract the comprised information on WLAN data availability.

Mobile terminal 200 then determines whether a desired availability is given. (action 213)

The information on WLAN data availability in the database could simply be a binary value, indicating whether sufficient data is available or not in the coverage area of the identified serving cell or cell sector. The data may be indicated to be sufficient, for example, if data for at least one WLAN access point is available for the area. Alternatively, the data may be considered sufficient, for example, if it can be expected to result in a better accuracy than a cellular based positioning.

Alternatively, the information on the availability of WLAN data could comprise a value indicating the density of WLAN access points in the coverage area of the identified serving cell or cell sector. The application could indicate a threshold value for a desired density, and mobile terminal 200 could determine whether the extracted density is at least equal to the indicated threshold value.

Further alternatively, the information on WLAN data could comprise a value indicating the accuracy that can be expected with the available WLAN data for the coverage area of the identified serving cell or cell sector. The application could indicate a threshold value for a desired accuracy, and mobile terminal 200 could determine whether the extracted expected accuracy is at least equal to the indicated threshold value.

In case the availability of WLAN data does not meet the required availability, the application may be informed. Optionally, it could be informed that positions are only available with the accuracy than can be achieved with cellular positioning, and determined cell based positions could be provided to the application. The application could be informed in this case, for instance, that positioning performance in the area has an accuracy of +/− 1 km, if this is a level that can be expected with cellular based positioning using cellular measurements on signals in network 420. (action 214)

In case the availability of WLAN data meets the required availability, mobile terminal 200 performs a WLAN scan by detecting WLAN signals transmitted by WLAN access points using transceiver 207. (action 215) The scan may provide mobile terminal 200 with an identity of visible WLAN access points and with associated Rx level values as an indication of received signal strengths.

Mobile terminal 200 causes a transmission of the results of the WLAN scan along with a WLAN positioning request to server 300. (action 216) The request can be transmitted to server 300 for instance via networks 420 and 410.

Server 300 receives the requests and computes the position of the terminal in a conventional manner based on the scan results and the WLAN radio maps stored in the database in memory 305. (action 311) For instance, mobile terminal 200 could be determined to be located in the intersection of the coverage areas of all detected WLAN access points, in case the database contains the coverage areas of WLAN access points. More precise positions could be determined based on received Rx levels and stored radio propagation model parameters.

Server 300 then causes a transmission of the determined position to mobile terminal 200. (action 312)

Mobile terminal 200 receives the position, including an uncertainty estimate, and provides it to the application that requested the position of mobile terminal 200. (action 217)

Actions 212 to 217 may be repeated in a loop, until the application indicates that position information is no longer needed.

Since no WLAN scans are performed in case a useful result cannot be expected anyhow, a significant amount of processing power may be saved at mobile terminal 200. Moreover, bandwidth and thus costs to a user may be saved, if no WLAN based positioning is requested, unless sufficient WLAN data for such positioning is known to be available. For instance, mobile terminal might detect a sufficient number of WLAN access points, but the database in memory 305 of server 300 might not contain any data for some or all of these WLAN access points. Since the checking of the availability of WLAN data is performed at mobile terminal 200, the result may be available quickly, and the need for a communication with server 300 can be avoided completely, in case attempting a WLAN based positioning is not promising.

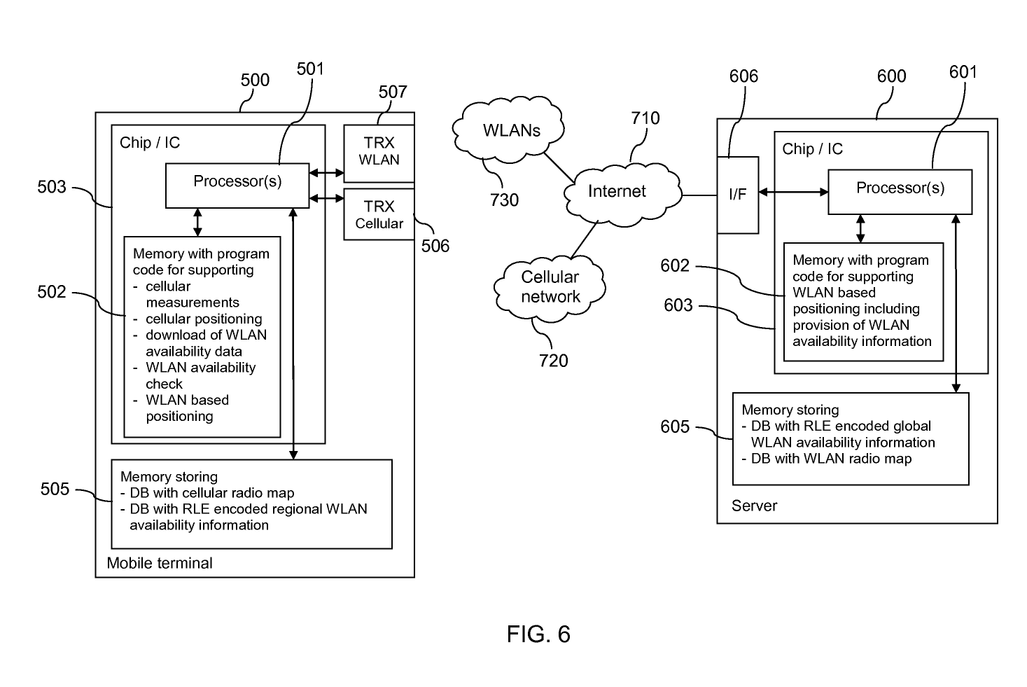

FIG. 6 is a schematic block diagram of a second exemplary system supporting an efficient WLAN based positioning.

The system comprises again a mobile terminal 500, a server 600, a network 710, a cellular network 720 and a plurality of WLANs 730. The structure is the same as in the system of FIG. 4, and reference is made to the description of the system of FIG. 4. In the following, only the differences between the systems will be discussed.

Mobile terminal 500 comprises a processor 501 that is linked to a first memory 502, to a second memory 505, to a cellular transceiver 506 and to a WLAN transceiver 507. Processor 501 and memory 502 may optionally belong to a chip or an integrated circuit 503.

Memory 502 stores computer program code for supporting a download of information on the availability of WLAN data from a server. Otherwise, memory 502 may store similar program code as memory 205 of mobile terminal 200.

Memory 505 stores a database with a cellular radio map. In this case, no information on the availability of WLAN data is embedded in the cellular radio map, though. Memory 505 stores in addition a database that is suited to comprise exchangeable regional RLE encoded information on the availability of WLAN data in a selected region.

Component 503 or mobile terminal 500 could correspond to exemplary embodiments of an apparatus according to the first aspect.

Server 600 comprises a processor 601 that is linked to a first memory 602, to a second memory 605 and to an interface (I/F) 606. Processor 601 and memory 602 may optionally belong to a chip or an integrated circuit 603.

Memory 602 stores computer program code for supporting WLAN based positioning of mobile terminals, which includes in this case program code for providing information about the availability of WLAN data to requesting mobile terminals.

Memory 605 stores a database with WLAN data enabling a WLAN based positioning. In this case, memory 605 stores in addition at least a database with global RLE encoded information on the availability of WLAN data. It is to be understood that one or both of the databases could also be stored in a memory that is external to server 600.

Using RLE coding may have the effect of reducing the amount of data that has to be stored. RLE is particularly suitable, when the availability is expressed by means of an index of a density of WLAN access points, by means of a bit indicating availability, by means of an index of an expected positioning accuracy or, in general, by means of an element selected from a limited set of elements.

It is to be understood, however, that the stored information on the availability of WLAN data does not have to be RLE encoded. It could also be stored for instance in a simple two-dimensional table or using any other suitable approach.

Component 603 or server 600 could correspond to exemplary embodiments of an apparatus according to the second aspect.

The main difference between the system of FIG. 4 and the system of FIG. 6 is that in the system of FIG. 4, the information about the availability of WLAN data may be pre-loaded to mobile terminal 200 along with the cellular radio map. In the system of FIG. 6, in contrast, mobile terminal 500 may download information about the availability of WLAN data for a selected region from server 600 and store corresponding data in memory 505 independently of a cellular radio map.

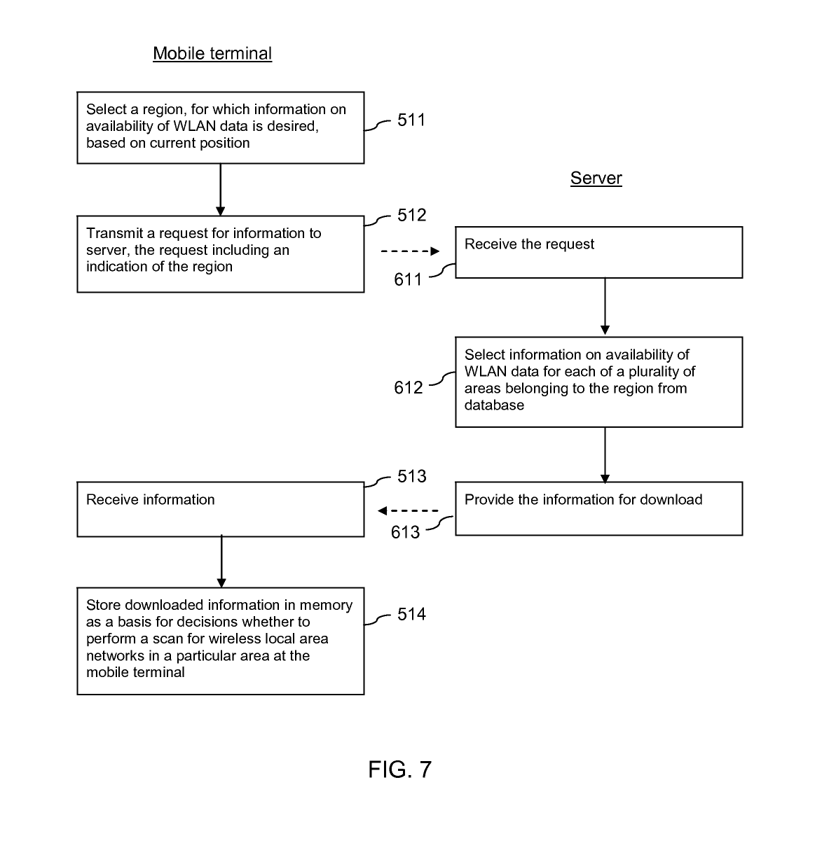

An exemplary operation in the system of FIG. 6 will now be described with reference to the flow chart of FIG. 7.

Operations at mobile terminal 500 are presented on the left hand side of FIG. 7. Processor 501 and the program code stored in memory 502 cause terminal 500 to perform the presented operations when the program code is retrieved from memory 502 and executed by processor 501. Operations at server 600 are presented on the right hand side of FIG. 7. Processor 601 and the program code stored in memory 602 cause server 600 to perform the presented operations when the program code is retrieved from memory 602 and executed by processor 601.

During an exemplary operation in the system of FIG. 7, mobile terminal 500 performs cellular measurements at regular intervals. Based on these measurements and the cellular radio map stored in a database in memory 505 mobile terminal 500 determines and tracks its position. If a more accurate position of mobile terminal 500 is desired, mobile terminal 500 determines a larger region in which it is located based on the position that has been determined based on the cellular measurements. (action 511)

Mobile terminal 500 then transmits a request for information about the availability of data on WLANs in the selected region to server 600. (action 512) It is to be understood that the request could also comprise the determined position instead of a selected region. In this case, the region could be selected at server 600.

Server 600 receives the request. (action 611)

Server 600 then selects information on the availability of WLAN data for each of a plurality of areas belonging to the selected region. (action 612) The information may be stored in the database for instance on a per tile basis, with each tile covering a predetermined area, or on a tile subregion basis. The relevant tiles or tile subregions may be determined based on the selected region. If the stored information is RLE encoded, it may be RLE decoded for the selection, and the selected information may be RLE encoded again. If the availability information in the database in memory 605 is not RLE encoded, the selected availability information may be RLE encoded. RLE may be very well-suited for a transport of the selected availability information from server 600 to terminal 500, since it may result in a significant reduction of the required bandwidth.

Server 600 then provides the selected information for download by mobile terminal 500. (action 613)

The information that is stored at server 600 and provided for download could comprise for each area, and thus for each relevant tile or for each subregion of a tile, a value indicating a density of WLAN access points for which data is available or a value indication the expected positioning accuracy based on the available WLAN data. Alternatively, it could comprise for each area a binary value on the availability of WLAN data. Using a binary value will keep the required bandwidth for the transmission to a minimum

Mobile terminal 500 receives the provided information. (action 513)

Thereafter, mobile terminal 500 stores the downloaded information in memory 505. (action 514) As a result, a subset of the global data stored at server 600 is now available at mobile terminal 500.

The stored information may then be used by mobile terminal 500 for deciding whether to perform a WLAN scan as a basis for an accurate positioning as long as mobile terminal 500 remains in the selected region. If mobile terminal 500 enters a new region, a new set of information may be downloaded and either be stored in addition or replace the previously downloaded information in memory 505. The decision whether to perform a WLAN scan may be performed for instance in a similar manner as described with reference to FIG. 5.

If the information is provided by server 600 on a per tile basis or a per sub-tile basis, a respective relevant tile or tile subregion may be determined based on a position of mobile terminal 500 that has been determined by means of a cellular positioning. If the information is received and stored at mobile terminal 500 in RLE encoded form, it has to be decoded before it can be evaluated.

It is to be understood that alternatively, server 600 could store and provide the information on the availability of WLAN data embedded in a regional cellular radio map. In this case, the relevant information could be retrieved from memory 505 based on a determined cell ID, as described with reference to FIG. 5. This means that mobile terminal 500 would not have to store a separate cellular radio map. Without a cellular radio map, mobile terminal 500 may not be able to determine its own rough position in advance based on cellular measurements. For this case, it may be provided that mobile terminal 500 sends the cell ID of its current serving cell to server 600 and that server 600 is configured to select a suitable region based on the received cell ID.

Summarized, certain embodiments of the invention may thus enable a mobile terminal to obtain the required information to make a decision on whether or not to attempt a WLAN scan and a WLAN based positioning. This may have the effect of saving energy and bandwidth.

It has to be noted that also mobile terminals with GNSS capability may benefit from using cellular/non-cellular positioning technologies, in order to accelerate the time-to-first-fix, using the obtained location as reference location, or in order to reduce the power consumption. Furthermore, not all applications require a GNSS based position. Furthermore, positioning technologies that are based on terrestrial radio signals may be better suited to work indoors than positioning technologies that are based on satellite signals.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101, 201 or 601 in combination with memory 102, 202 or 602, respectively, or the integrated circuit 203 or 603 can also be viewed as means for retrieving information on an availability of data on wireless local area networks for a particular area from a memory, the particular area being identified based on cellular measurements at a mobile terminal, and as (additional or separate) means for providing the retrieved information as a basis for a decision whether to perform a scan for wireless local area networks at the mobile terminal as a basis for a wireless local area network based positioning. The functions illustrated by processor 101, or 501 in combination with memory 102 or 502, respectively, or the integrated circuit 503 can also be viewed as means for requesting from a server, by a mobile terminal, information on an availability of data on wireless local area networks for a particular area, the particular area being identified based on cellular measurements at the mobile terminal, as (additional or separate) means for receiving, by the mobile terminal, from the server information on an availability of data on wireless local area networks for the particular area; and as (additional or separate) means for using, by the mobile terminal, the received information for deciding whether to perform a scan for wireless local area networks as a basis for a wireless local area network based positioning.

The program codes in memory 102, 202, 602 and 502, respectively, can also be viewed as comprising such means in the form of functional modules.

FIGS. 2, 3, 5 and 7 may also be understood to represent exemplary functional blocks of a computer program code for supporting a wireless local area network based positioning.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-26. (canceled)

27. A method comprising:
retrieving, by an apparatus, information on an availability of data on wireless local area networks for a particular area from a memory, the particular area being identified based on cellular measurements at a mobile terminal; and
providing, by the apparatus, the retrieved information as a basis for a decision whether to perform a scan for wireless local area networks at the mobile terminal as a basis for a wireless local area network based positioning.

28. The method according to claim 27, wherein the memory comprises information on an availability of data on wireless local area networks embedded in a cellular radio map.

29. The method according to claim 27, wherein available data on wireless local area networks is stored separately from the information on an availability of data on wireless local area networks.

30. The method according to claim 27, wherein the memory comprises for each of a plurality of areas at least one of:
a value indicating a density of wireless local area network access points for which data is available;
a binary value indicating an acceptable availability of wireless local area network data; and
a value indicating an expected accuracy of a wireless local area network based positioning in the area.

31. The method according to claim 27, wherein the particular area corresponds to one of:
a cell area;
a cell sector;
a tile area; and
a tile subregion.

32. The method according to claim 27, wherein the particular area is identified by one of a cell identity and a location of the mobile terminal determined by means of a cell based positioning.

33. The method according to claim 27, further comprising informing an application about an achievable positioning accuracy.

34. The method according to claim 27, further comprising as a preceding step at a mobile terminal:
requesting and receiving from a server information on an availability of data on wireless local area networks for a plurality of areas; and
causing a storage of the received information in the memory as a basis for the retrieving of information on an availability of data on wireless local area networks for the particular area.

35. A method comprising:
receiving, by a server, a request from a mobile terminal for information on an availability of data on wireless local area networks for each of a plurality of areas; and
providing, by the server, the requested information to the mobile terminal, as a basis for decisions at the mobile terminal whether to perform a scan for wireless local area networks in a particular area.

36. An apparatus comprising at least one processor and at least one memory including computer program code, the at least one memory and the computer program code configured to, with the at least one processor, cause an apparatus at least to perform:
retrieve information on an availability of data on wireless local area networks for a particular area from a memory, the particular area being identified based on cellular measurements at a mobile terminal; and
provide the retrieved information as a basis for a decision whether to perform a scan for wireless local area networks at the mobile terminal as a basis for a wireless local area network based positioning.

37. The apparatus according to claim 36, wherein the memory comprises information on an availability of data on wireless local area networks embedded in a cellular radio map.

38. The apparatus according to claim 36, wherein available data on wireless local area networks is stored separately from the information on an availability of data on wireless local area networks.

39. The apparatus according to claim 36, wherein the memory comprises for each of a plurality of areas at least one of:
a value indicating a density of wireless local area network access points for which data is available;
a binary value indicating an acceptable availability of wireless local area network data; and
a value indicating an expected accuracy of a wireless local area network based positioning in the area.

40. The apparatus according to claim 36, wherein the particular area corresponds to one of:
a cell area;
a cell sector;
a tile area; and
a tile subregion.

41. The apparatus according to claim 36, wherein the computer program code is configured to, with the at least one processor, cause the apparatus to identify the particular area by one of a cell identity and a location of the mobile terminal determined by means of a cell based positioning.

42. The apparatus according to claim 36, wherein the computer program code is configured to, with the at least one processor, cause the apparatus to inform an application about an achievable positioning accuracy.

43. The apparatus according to claim 36, wherein the computer program code is configured to, with the at least one processor, cause a mobile terminal to:
request and receive from a server information on an availability of data on wireless local area networks for a plurality of areas; and
store the received information in the memory as a basis for the retrieving of information on an availability of data on wireless local area networks for the particular area.

44. The apparatus according to claim 36, further comprising at least one of:
a memory storing information on an availability of data on wireless local area networks for each of a plurality of areas;
a memory storing information on an availability of data on wireless local area networks for each of a plurality of areas embedded in data of a cellular radio map;
a memory storing data of a cellular radio map; and
a memory storing data on wireless local area networks.

45. The apparatus according to claim 36, wherein the apparatus is one of:
a server;
a component for a server;
a mobile terminal; and
a component for a mobile terminal.
